(19) United States
(12) Patent Application Publication
(10) Pub. No.: US 2014/0259927 A1
(43) Pub. Date: Sep. 18, 2014

(54) CONTROLLER FOR A DOOR OPERATOR

(71) Applicant: Yale Security Inc., Monroe, NC (US)

(72) Inventor: Tommy G. McNally, II, Indian Trail, NC (US)

(73) Assignee: Yale Security Inc., Monroe, NC (US)

(21) Appl. No.: 14/216,102

(22) Filed: Mar. 17, 2014

Related U.S. Application Data
(60) Provisional application No. 61/789,496, filed on Mar. 15, 2013.

(51) Int. Cl. E05F 15/00

(52) U.S. Cl. CPC E05F 15/00
USPC 49/13; 49/506

(57) ABSTRACT

A communicating apparatus comprises a base unit connected to a door operator, the base unit including a processor, a display coupled to the processor, a user input device coupled to the processor to allow the processor to read the state of the input device, the state of the input device being selected by the user, and a memory module coupled to the processor, the memory module storing code executed by the processor. The processor code displays to the user various menu items, enables the user to scroll among the menu items using the input device, and enables the user to select the menu item such that the processor derives a control signal. A circuitry is configured to receive the control signal from the processor and to carry the control signal to the door operator.

### CROSS REFERENCES

This application is related to U.S. provisional application No. 61/789,496, filed Mar. 15, 2013, entitled “CONTROLLER FOR A DOOR OPERATOR”, naming Tommy G. McNally II as the inventor. The contents of the provisional application are incorporated herein by reference in their entirety, and the benefit of the filing date of the provisional application is hereby claimed for all purposes that are legally served by such claim for the benefit of the filing date.

### BACKGROUND

A door operator for a door is described and, more particularly, a door operator including interactive control and monitoring for selectively setting operating parameters of the door.

The purpose of door operators is to open and close a door. Automatic door operators are used on public buildings and residences to allow for access by the physically disabled or where manual operation of the door may be inconvenient to users. In public facilities, it is a required American National Standard that doors which provide ingress and egress have the ability to open automatically in order to allow handicapped people passage through the doorway.

A variety of electro-mechanical automatic door operators are known. A typical electromechanical door operator includes an electric motor and a linkage assembly for operatively coupling the drive shaft of the motor to a door so that the door will be opened and closed when the drive shaft rotates. Activation of the door operator is initiated by means of an electric signal generated in a variety of ways such as, for example, a pressure switch, an ultrasonic or photoelectric presence sensor, motion sensors, radio transmitters, wall switches, and the like. The door may then be closed under power or with a door closer. A conventional door closer uses an internal spring mechanism which is compressed during the opening of the door for storing sufficient energy so that the door can be returned to a closed position without the input of additional electrical energy.

In door operators, the automatic, powered opening system and door closer are controlled by switches, sensors, and valves. Typically, technicians installing door operators perform set up and adjustment of different parameters. Each time, the technician must gain access to a control board of the door operator, usually by removing a cover or gate operator housing, to make the desired adjustments.

There is need for a system and method for establishing communication with door operators to initiate their performance and make any desired adjustments. Moreover, it would be advantageous to provide centralized control for setting the door operating parameters.

### SUMMARY

An apparatus is provided for enabling a user to communicate with a door operator. The communicating apparatus comprises a base unit connected to the door operator, the base unit including a processor, a display coupled to the processor to display information to the user under control of the processor, a user input device coupled to the processor to allow the processor to read the state of the input device, the state of the input device being selected by the user, and a memory module coupled to the processor, the memory module storing code executed by the processor. The processor under control of the code displays to the user various menu items on the display, enables the user to scroll among the menu items to point to one of the menu items using the input device, and enables the user to select the menu item that is pointed to by using the input device such that the processor derives a control signal, A circuitry is configured to receive the control signal from the processor and to carry the control signal to the door operator.

A method is also provided for a user to communicate with a door operator for controlling a door through a user input. The method comprises the steps of connecting a communication apparatus to the door for the user to communicate with the door operator, receiving a command signal from the user, deriving a control signal from the command signal, and sending the control signal to the door operator to control a parameter of door movement.

In another aspect, a monitoring device provides for for a user to communicate with a door operator through a user input. The monitoring device comprises an interface to connect the monitoring device to the door operator, a circuitry configured to receive a command signal from the user, a controller for deriving a control signal from the command signal, and receiving a response signal from the door operator carrying a data responsive to the control signal, a second circuitry configured to carry the control signal to the door operator; and a display configured to present the data in a graphical and an alphanumerical format. The data comprises a set of information from a sensor connected to the door operator.

### BRIEF DESCRIPTION OF THE DRAWINGS

For a more complete understanding of the present invention, reference should now be had to the embodiments shown in the accompanying drawings and described below. In the drawings:

FIG. 1 is a perspective view of an embodiment of a push-side mounted door operator.

FIG. 2 is a perspective view of an embodiment of a pull-side mounted door operator.

FIG. 3 is a plan view of a controller unit for use with the door operator as shown in FIGS. 1 and 2.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGS. Indeed, the referenced components may be oriented in any direction and the terminology, therefore, should be understood as encompassing such variations unless specified otherwise.

As used herein, the term “open position” for a door means a door position other than a closed position, including any position between the closed position and a fully open position as limited only by structure around the door frame, which can be up to 180.degree. from the closed position.

Referring now to the drawings, wherein like reference numerals designate corresponding or similar elements throughout the several views, a door operator according to the present invention is shown in FIG. 1 and generally designated at 40. The door operator 40 is mounted adjacent to a door 42 in a door frame 44 for movement of the door 42 relative to the frame 44 between a closed position and an open position. For the purpose of this description, only the upper portion of the door 42 and the door frame 44 are shown. The door 42 is of a conventional type and is pivotally mounted to the frame 44 for movement from the closed position, as shown in FIG. 1, to an open position for opening and closing an opening through a building wall 48 to allow a user to travel from one side of the wall 48 to the other side of the wall 48.

The door operator 40 comprises a back plate 50, a motor assembly 52, a door closer assembly 54 including a linkage assembly 56 for operably coupling the door operator 40 to the door 42, and a controller 58. The back plate 50 has substantially flat rear wall 60 and end walls 62. The back plate 50 is securely mounted to the upper edge of the door frame 44 using mounting bolts (not shown), or other fasteners. The back plate 50 extends generally horizontally with respect to the door frame 44. The motor assembly 52, door closer assembly 54, and controller 58 are fixed to the back plate 50. A cover (not shown) attaches to the back plate 50. The cover serves to surround and enclose the components of the door operator 40 to reduce dirt and dust contamination, and to provide a more aesthetically pleasing appearance. It is understood that although the back plate 50 is shown mounted directly to the door frame 44, the back plate 50 could be mounted to the wall 48 adjacent the door frame 44 or concealed within the wall 48 or door frame 44. Concealed door operators are well known in the art of automatic door operators.

A system and method is provided for sending and receiving information to and from the door operator 50 to allow controlling, monitoring and adjusting information pertaining to operating parameters of the door operator. The control system assists a user, for example an installer, technician, service man or repair man to set, adjust, command, test, troubleshoot, configure, upgrade or monitor a door operator, as well as any other device connected to the same power grid. It is understood that a door operator can be any system that controls a barrier to an entry, an exit, or a view, for example, a door operator, a garage door opener, or the like. The barrier could be a door or window for a small entity, or a gate for a large entity (i.e. a vehicle), which can swing out, slide open, or even roll upwards. The operator, which moves the barrier or gate from an open position to a closed position and vice-versa, can be manual or automatic.

Referring to FIG. 3, a controller unit 70 comprises a processor, e.g., a microprocessor or a microcontroller, with memory for storing instructions and data. Some of the memory is non-volatile, storing configuration information and program code. An LCD display screen 72 of the controller 70 displays various menus, icons, and other information to the user under direction of the processor. The display screen 72 displays information received or stored in the controller. Of course, any type of display may be implemented without departing from the scope of the present invention. In one embodiment, the display screen 72 is self-illuminating to assist in dark work environments. The user can scroll through the menus and icons using an input device, for example, a joystick 74, which may include an internal push-to-activate switch. The processor is connected to the input device so that it can read the status of the input device. Moving the joystick 74 instructs the processor to cause the display to scroll through the menus. Pushing on the joystick 74 with an internal push-to-activate switch instructs the processor that the current menu items have been selected by the user.

Like door operators, the controller 70 may derive power from the power grid. However, the controller 70 may also be battery operated in case that a power failure occurs or is not plugged in to a power source when using both sources of power. In an exemplary embodiment, the controller 70 comprises a rechargeable battery so that the device may be operated without the need for a separate power source. In another embodiment, the controller 70 also comprises a power cord that may be extended from the controller to access any available power grid. A power grid interface derives power from a power line and in turn supplies current to both the power supply and other circuitry. The power supply feeds power to various components of monitoring device including charger, battery, and CPU.

The display screen 72 is configured to present data in a graphical and alphanumerical format. In an exemplary embodiment, the controller 70 is capable of providing graphical and numerical depictions of the internal parameters of the door operator. The CPU communicates with the controller 70 to send information to the display screen 72. In another embodiment, the controller 70 uses a combination of graphical representations, text messages, and light indicators to represent data. In another embodiment, text messages on the screen 72 inform the user of real time events as they occur. In yet another embodiment, the controller 70 may comprise light indicators that light up when a particular event takes place. The graphical or text representations will allow the technician to set or adjust the parameters. This is desirable in the industry as many users have different requirements for the use of their doors and technicians are required to make adjustments.

The input interface, along with joystick 74 control combined with internal components, such as a CPU and a memory, allow a user implementing the control system to receive, process, and send information. In use, set up and adjustment of the inverter and door operator are performed with the joystick 74. The LCD screen 72 shows the feature to be adjusted and the setting. A small potentiometer (“pot”) beside the LCD interface can be used to adjust the LCD screen contrast. To scroll through menu items, the joystick is moved toward “MENU ↑ UP” to scroll up or toward “MENU ↓ DOWN” to scroll down. To change the value of a feature, the joystick is moved toward “INCR→” to increase the value or toward ←DECR” to decrease the value. To accept the value, the joystick is pushed inwardly. Once set up or adjustment of the desired features is completed, the joystick is used to scroll down the menu to the “Save” line, and the joystick is pushed in to accept all of the values.

Some of the features that may be set and adjusted include hand of the door, whether left hand or right hand mounted. The mounting of the door is also designated as a push or pull, depending on the side of the door on which the unit is mounted. There is a “Push N Go” feature, which may be on or off. If “off”, the unit depends on an external switch for activation. If “on”, the unit will operate with a slight movement of the door toward the open position. Even if “on”, external switches may also be used for activation.

Obstruction detection and delay sensitivity may be adjusted. The range of delay may be about 0 to about 5 seconds, and adjustable in 1 second increments. During the opening cycle, the door will press against an obstruction for the obstruction delay time set and then close normally under spring force. During the closing cycle, the door will press against an obstruction for the time set under a feature entitled “Hold Time”. The door will then reclose. If the obstruction is still present, power to the unit will turn off with only the spring force pushing the door against the obstruction.

A “Latch Boost” feature can be adjusted to “Off”, “Low”, or “High”. For example, if during the last few inches of door closing, the door does not close due to mechanical door issues, environment issues, and the like, additional force can be added to close the door.

The time the door is held at the fully open position can be adjusted from about 0 to about 30 seconds in, for example, 3 second increments. A delay to the motor start can be set in one second increments from, for example, about 0 to about 5 seconds before the unit starts to allow unlocking of electric hardware. The length of time a relay will stay energized for powered latch retraction can be adjusted, for example, in 3 second increments, from about 0 to about 30 seconds. Alarm delay can be “Off” or set, for example, at about 30 seconds, about 60 seconds, and the like.

A number of items may be recorded and tracked. The number of open/close cycles the unit has experienced can be recorded. The number of days the unit has been powered to 120 VAC can be recorded. The time for the previous opening cycle and the previous closing cycle can also be recorded. The control unit can be used to set the closed and open position of the door. Again, once all adjustments have been made, the joystick is pushed in to save the values.

In one embodiment, a remote controller is built into a personal digital assistant (PDA) loaded with and executing special-purpose code. An RF (or other wireless) communication card plugs into a port of the PDA and performs wireless communication functions under control of the PDA. The screen of the PDA acts as the display of the remote controller, and the manual input devices of the PDA—a keyboard or stylus-like pen—is used to scroll and select the menu items. The PDA can also provide electrical power to the RF communication card.

In another embodiment, the remote controller includes a port for downloading software, icon and/or other control, data for use by the remote controller in the course of operating its controlled systems. The data enables the remote controller, for example, to operate additional controlled systems, and to display new icons.

In one embodiment, the controller can be uploaded with an installation manual accessible to a technician for review. For example, and without limiting the scope of the description, an installation manual for a door operator may be displayed for a technician while working with the unit in the field. This information may be desirable during installation, maintenance, or adjustment of gate operators. Additionally, the controller may comprise a USB interface which may be used to upload or upgrade firmware for the controller. Further, a serial port interface provides yet another connectivity option for the controller to hook up to other devices for the transfer of communication.

The controller has many advantages, including providing installers and manufacturers with a means to set, adjust, command, test, troubleshoot, configure, upgrade or monitor door operators.

Although the controller has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the controller, particularly in light of the foregoing teachings. Accordingly, I intend to cover all such modifications, omission, additions and equivalents as may be included within the spirit and scope of the description of the controller invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. An apparatus for enabling a user to communicate with a door operator, the communicating apparatus comprising:
a base unit connected to the door operator, the base unit including
a processor,
a display coupled to the processor to display information to the user under control of the processor,
a user input device coupled to the processor to allow the processor to read the state of the input device, the state of the input device being selected by the user, and
a memory module coupled to the processor, the memory module storing code executed by the processor,
wherein the processor under control of the code displays to the user various menu items on the display, enables the user to scroll among the menu items to point to one of the menu items using the input device, and enables the user to select the menu item that is pointed to by using the input device such that the processor derives a control signal; and
a circuitry configured to receive the control signal from the processor and to carry the control signal to the door operator.

2. The communicating apparatus of claim 1, wherein the display is configured to present the data in a graphical and an alphanumerical format.

3. The communicating apparatus of claim 1, wherein the user input device comprises a joystick with an internal push-to-activate switch operable by depressing the joystick in a direction along a longitudinal axis of the joystick and releasing the joystick.

4. The communicating apparatus of claim 1, wherein each of the menu items corresponds to at least one parameter of a plurality of door parameters to be performed by the door operator.

5. The communicating apparatus of claim 4, wherein the at least one parameter comprises a hand of the door.

6. The communicating apparatus of claim 4, wherein the at least one parameter comprises a push or pull mounted door.

7. The communicating apparatus of claim 4, wherein the at least one parameter comprises a hold-open time of the door.

8. The communicating apparatus of claim 1, further comprising a sensor connected to the door, wherein the controller receives a response signal from the door carrying a data from the sensor responsive to the control signal to the door operator.

9. The communicating apparatus of claim 8, wherein the data comprises a door position.

10. The communicating apparatus of claim 1, further comprising an internal storage for retrieval and display of a preloaded installation instruction manual.

11. The communicating apparatus of claim 10, wherein the preloaded installation instruction manual includes an installation steps, a drawing, a dimension, and a set of procedures.

12. The communicating apparatus of claim 1, wherein a USB interface is connected to the processor to allow for software upgrades.

13. The communicating apparatus of claim 1, further comprising a transmitter coupled to the processor, and a remote control for enabling the user to remotely control the door operator.

14. A method for a user to communicate with a door operator for controlling a door through a user input, the method comprising the steps of:
connecting a communication apparatus to the door for the user to communicate with the door operator;
receiving a command signal from the user;
deriving a control signal from the command signal; and
sending the control signal to the door operator to control a parameter of door movement.

15. The method of claim 14, further comprising displaying data on the communication device.

16. The method of claim 14, further comprising a sensor connected to the door operator, wherein a response signal from the door operator comprises a signal from the sensor.

17. The method of claim 14, further comprising the step of monitoring the door that is connected to the door operator.

18. The method of claim 14, wherein the communication apparatus diagnoses and analyzes an operation of the door that is connected to the door operator.

19. The method of claim 14, wherein the communication unit is used to adjust a parameter of the door selected by the user.

20. The method of claim 14, further comprising a remote connector, wherein the remote connector is used to upgrade a software of the communication unit that is connected to the door operator.

21. A monitoring device for a user to communicate with a door operator through a user input, the monitoring device comprising:
an interface to connect the monitoring device to the door operator;
a circuitry configured to receive a command signal from the user;
a controller for deriving a control signal from the command signal, and receiving a response signal from the door operator carrying a data responsive to the control signal;
a second circuitry configured to carry the control signal to the door operator; and
a display configured to present the data in a graphical and an alphanumerical format,
wherein the data comprises a set of information from a sensor connected to the door operator.

22. The monitoring device of claim 21, further comprising an input data port capable of receiving the code executed by the processor
